(19) United States
(12) Patent Application Publication
(10) Pub. No.: US 2026/0322525 A1
(43) Pub. Date: Oct. 15, 2026

(54) MULTIPLE MODULATION AND CODING SCHEME LEVELS

(71) Applicant: Lenovo (United States) Inc., Morrisville, NC (US)

(72) Inventors: Alexander Golitschek Edler von Elbwart, Darmstadt (DE); Joachim Löhr, Wiesbaden (DE); Ravi Kuchibhotla, Chicago, IL (US)

(73) Assignee: Lenovo (United States) Inc., Morrisville, NC (US)

(21) Appl. No.: 19/170,871

(22) Filed: Apr. 4, 2025

(51) Int. Cl. H04L 1/00; H04W 72/21; H04W 72/232

(52) U.S. Cl. CPC H04L 1/0009; H04L 1/0003; H04W 72/21; H04W 72/232

(57) ABSTRACT

Various aspects of the present disclosure relate to multiple modulation and coding scheme (MCS) levels. A user equipment (UE) receives downlink control information (DCI) is that allocates at least one set of resource blocks (RBs). The UE transmits, using a first MCS level of a plurality of MCS levels, a first data block on a first subset of RBs of the at least one set of RBs, and transmits, using a second MCS level of the plurality of MCS levels, a second data block on a second subset of RBs of the at least one set of RBs, wherein the first MCS level is different from the second MCS level.

### TECHNICAL FIELD

The present disclosure relates to wireless communications, and more specifically to multiple modulation and coding scheme (MCS) levels.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive downlink control information (DCI) that allocates at least one set of resource blocks (RBs); transmit, using a first MCS level of a plurality of MCS levels, a first data block on a first subset of RBs of the at least one set of RBs; and transmit, using a second MCS level of the plurality of MCS levels, a second data block on a second subset of RBs of the at least one set of RBs, where the first MCS level is different from the second MCS level.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that allocates at least one set of RBs; transmit, using a first MCS level of a plurality of MCS levels, a first data block on a first subset of RBs of the at least one set of RBs; and transmit, using a second MCS level of the plurality of MCS levels, a second data block on a second subset of RBs of the at least one set of RBs, where the first MCS level is different from the second MCS level.

A method performed or performable by a UE for wireless communication is described. The method may include receiving DCI that allocates at least one set of RBs; transmitting, using a first MCS level of a plurality of MCS levels, a first data block on a first subset of RBs of the at least one set of RBs; and transmitting, using a second MCS level of the plurality of MCS levels, a second data block on a second subset of RBs of the at least one set of RBs, where the first MCS level is different from the second MCS level.

In some implementations of the UE, the processor, and the method described herein, the DCI indicates the first MCS level. In some implementations of the UE, processor, and method described herein, the UE, processor, and method may further be configured to, capable of, performed, performable, or operable to receive an indication of a set of multiple MCS levels; and select, as the second MCS level, one of the MCS levels in the set of multiple MCS levels.

In some implementations of the UE, processor, and method described herein, the DCI indicates frequency resources for transmission of the first data block. In some implementations of the UE, processor, and method described herein, the first MCS level is based at least in part on quality of service (QoS) requirements of a highest priority logical channel (LCH) associated with data available in a buffer of the UE.

In some implementations of the UE, processor, and method described herein, the UE, processor, and method may further be configured to, capable of, performed, performable, or operable to select the second MCS level of the plurality of MCS levels based at least in part on a priority of a LCH associated with the second data block. In some implementations of the UE, processor, and method described herein, the UE, processor, and method may further be configured to, capable of, performed, performable, or operable to multiplex the first data block and the second data block in a single transport block (TB).

In some implementations of the UE, processor, and method described herein, the UE, processor, and method may further be configured to, capable of, performed, performable, or operable to transmit uplink control information (UCI) that indicates the second MCS level. In some implementations of the UE, processor, and method described herein, to transmit the UCI, the UE, processor, and method may further be configured to, capable of, performed, performable, or operable to transmit the UCI using at least one of a predefined MCS level or the first MCS level. In some implementations of the UE, processor, and method described herein, to transmit the UCI, the UE, processor, and method may further be configured to, capable of, performed, performable, or operable to transmit the UCI using the third MCS level.

An NE (e.g., a base station) for wireless communication is described. The NE may be configured to, capable of, or operable to perform one or more operations as described herein. For example, the NE may be configured to, capable of, or operable to transmit DCI that allocates at least one set of RBs; receive, using a first MCS level of a plurality of MCS levels, a first data block on a first subset of RBs of the at least one set of RBs; and receive, using a second MCS level of the plurality of MCS levels, a second data block on a second subset of RBs of the at least one set of RBs, where the first MCS level is different from the second MCS level.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to transmit DCI that allocates at least one set of RBs; receive, using a first MCS level of a plurality of MCS levels, a first data block on a first subset of RBs of the at least one set of RBs; and receive, using a second MCS level of the plurality of MCS levels, a second data block on a second subset of RBs of the at least one set of RBs, where the first MCS level is different from the second MCS level.

A method performed or performable by an NE (e.g., a base station) for wireless communication is described. The method may include transmitting DCI that allocates at least one set of RBs; receiving, using a first MCS level of a plurality of MCS levels, a first data block on a first subset of RBs of the at least one set of RBs; and receiving, using a second MCS level of the plurality of MCS levels, a second data block on a second subset of RBs of the at least one set of RBs, where the first MCS level is different from the second MCS level.

In some implementations of the NE, processor, and method described herein, the NE, processor, and method may further be configured to, capable of, performed, performable, or operable to include, in the DCI, an indication of the first MCS level. In some implementations of the NE, processor, and method described herein, the NE, processor, and method may further be configured to, capable of, performed, performable, or operable to include, in the DCI, an indication of a set of multiple MCS levels.

In some implementations of the NE, processor, and method described herein, the NE, processor, and method may further be configured to, capable of, performed, performable, or operable to receive UCI that indicates the second MCS level of the plurality of MCS levels. In some implementations of the NE, processor, and method described herein, the DCI indicates frequency resources for transmission of the first data block.

In some implementations of the NE, processor, and method described herein, the NE, processor, and method may further be configured to, capable of, performed, performable, or operable to receive a buffer status report; and determine the first MCS level based at least in part on QoS requirements of a highest priority LCH associated with data indicated in the buffer status report. In some implementations of the NE, processor, and method described herein, the first data block is multiplexed with the second data block in a single TB.

In some implementations of the NE, processor, and method described herein, the NE, processor, and method may further be configured to, capable of, performed, performable, or operable to receive an UCI using at least one of a predefined MCS level or the first MCS level. In some implementations of the NE, processor, and method described herein, the NE, processor, and method may further be configured to, capable of, performed, performable, or operable to include, in the DCI, an indication of a third MCS level, and receive an UCI using the third MCS level.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of channel fluctuation in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

In a wireless communications system, a TB refers to a block of data (e.g., a data payload) communicated (e.g., transmitted, sent, output, received, signaled) between a physical layer and one or more higher layers (e.g., medium access control (MAC) layer). At a transmitter side, the MAC layer organizes data to be communicated (e.g., transmitted, sent, signaled) into TBs, and the physical layer processes (e.g., encodes, modulates) the TBs for communication (e.g., transmission, sending, signaling). At a receiver side, the physical layer processes (e.g., decoding process, demodulation process) the communication (e.g., reception, received) signal to extract the TBs, and provides the TBs to the MAC layer. The TB can be divided into multiple smaller blocks referred to as data blocks or code block groups, allowing larger amounts of data to be encoded, transmitted, and decoded efficiently. Different data blocks can be grouped into or associated with different logical channels (LCHs), where each LCH can carry different types of data (e.g., control data, user data, signaling data, and so forth). Each LCH can be associated with a different priority (e.g., with higher priority LCHs having higher quality of service (QoS) requirements or settings than lower priority LCHs).

A data block is communicated (e.g., transmitted, sent, signaled) on one or more resource blocks (RBs). A resource block (RB) refers to a unit of time and frequency resources. For example, for 5G NR, an RB may include 12 subcarriers in the frequency domain and a number of OFDM symbols in the time domain (e.g., depending on the subcarrier spacing).

Some wireless communications systems, such as 6G systems, may support a bandwidth in a wider range than previous wireless communications systems, such as a bandwidth in the range of approximately 100 megahertz (MHz) or more. In such situations, the radio channel (e.g., depending on the environment and/or deployment) may face not only small-scale fluctuations within a few decibels (dB), but may see larger fluctuations as well. This may be compensated for in link adaptation by selecting an MCS that is adapted to the average link quality over the assigned bandwidth. Different MCS levels refer to different coding rates and/or modulation schemes. A table or other data structure of different coding rate and modulation scheme combinations can be known to both the UE and the NE, with an index into the table or other data structure being used to identify which of the different MCS levels is being used.

The techniques discussed herein describe supporting multiple levels of MCS per TB for a downlink (DL) resource assignment or an uplink (UL) resource grant. Since the NE (e.g., a gNB) has an imperfect knowledge or estimate about the buffer size and TB generation at the UE side, the UE may be better able to determine appropriate MCS levels for different data blocks (e.g., for different logical channel (LCH) data). Accordingly, this disclosure presents solutions how to determine and signal MCS levels for different parts of a TB or different concurrently transmitted TBs. For example, a UE receives DCI that allocates at least one set of RBs to the UE. The at least one set of RBs may be indicated as one or more RBs that may be contiguous or non-contiguous. In a simple form, the DCI may indicate a single range of RBs, which encompasses multiple sets of allocated RBs; additionally, or alternatively, the DCI may indicate multiple ranges of RBs, where one RB range is associated with one or more RB sets. The UE selects or uses a first MCS level and communicates (e.g., transmits, sends, signals) at least one data block on a first subset of RBs of the at least one set of RBs using the first MCS level, and selects or uses a second MCS level and communicates (e.g., transmits, sends, signals) at least one data block on a second subset of RBs of the at least one set of RBs using the second MCS level. The UE can select which MCS level to use based on various criteria, such as QoS requirements or priority of the logical channel associated with (e.g., that includes) the data block. For the initial or first data block communicated (e.g., transmitted, sent, signaled) by the UE, the UE can select or use an MCS level in a manner that allows the NE to know which MCS level was selected (e.g., the MCS level for the initial or first data block may be a predetermined or preidentified MCS level, may be indicated to the UE in the DCI).

In contrast to systems that support only a single MCS level per TB for a DL resource assignment or a UL resource grant, by supporting multiple levels of MCS per TB the communication link between the UE and the NE can be adapted to exploit frequency ranges with better signal-to-interference-plus-noise ratio (SINR) by a reduced forward error correction (FEC) overhead, and can assign a more robust FEC to data mapped on frequency ranges with a poor MCS. Example usage scenarios include situations where the wireless communications system has very narrow beams, where there is no or extremely limited flexibility to assign frequency ranges according to the best channel out of the plurality of UEs (such as RB range 1 to UE #1 with good SINR, RB range 2 to UE #2 with good SINR).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

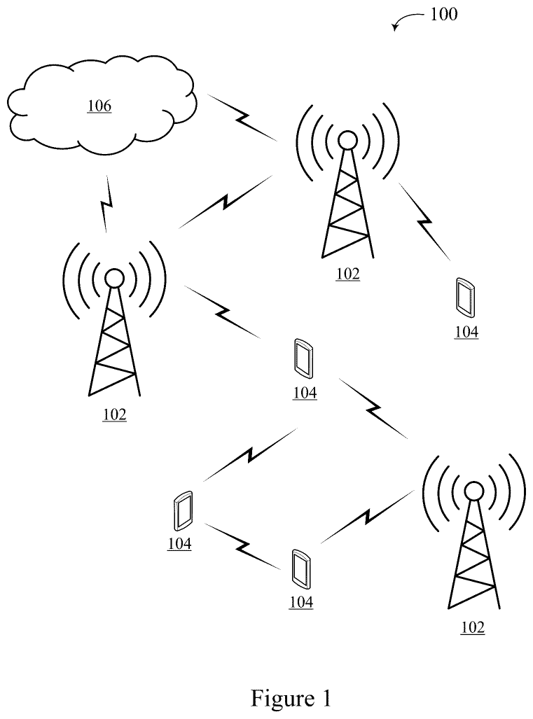

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Using the techniques discussed herein, different MCS levels can be used when communicating data between the UEs 104 and the NEs 102. For UL data, the UE 104 can select the MCS level for a data block based on one or more of various criteria, such as QoS requirements or priority of the logical channel associated with (e.g., that includes) the data block. Furthermore, the UE 104 can select and transmit data blocks using different MCS levels within the same TB.

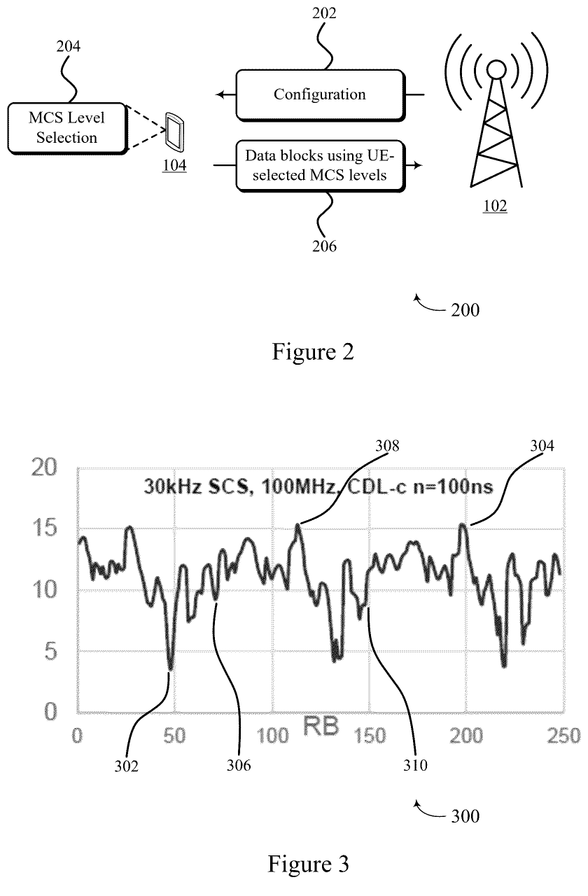

FIG. 2 illustrates an example 200 of wireless communication in accordance with aspects of the present disclosure. In the example 200, an NE 102 communicates (e.g., transmits, sends, signals) a configuration 202 (e.g., a configuration message) to a UE 104. The configuration 202 (e.g., DCI) allocates at least one set of RBs to the UE 104. The UE 104 performs MCS level selection 204 to select an MCS level for each of one or more sets of data blocks (e.g., an MCS level for data blocks associated with a particular LCH). The UE 104 communicates (e.g., transmits, sends, signals), to the NE 102, the data blocks 206 using the UE-selected MCS levels.

Accordingly, the UE 104 can multiplex multiple data blocks and assign different MCS levels to each of those data blocks, and then transmit the multiplexed data blocks in one UL transmission to the NE 102. So, although the configuration 202 assigns the UL resources (e.g., the sets of RBs), the UE 104 rather than the NE 102 assigns or determines the MCS used for the different parts of those frequency resources. Additionally, or alternatively, the UE 104 rather than the NE 102 assigns or determines which part of the data goes into which part of the UL resources.

FIG. 3 illustrates an example 300 of channel fluctuation in accordance with aspects of the present disclosure. The example 300 illustrates signal-to-interference-plus-noise ratio (SINR) in a transmit (Tx) wireless communication channel having 30 kilohertz (kHz) subcarrier spacing (SCS) across a 100 MHz bandwidth, using a clustered delay line (CDL) profile CDL-C where n=100 nanoseconds. As illustrated, the Tx channel has channel fluctuation of greater than 10 dB, such as from approximately 4 dB at 302 to over 15 dB at 304. Using the techniques discussed herein, the UE 104 can select a less conservative MCS level for RB 75 through RB 120 because the channel fluctuation between RB 75 and RB 120 is approximately 6 dB (e.g., 9 dB at 306 and 15 dB at 308) and a more conservative MCS level for RB 120 through RB 150 because the channel fluctuation between RB 120 and RB 150 is approximately 11 dB (e.g., 15 dB at 308 and 4 db at 310).

Returning to FIG. 1, with respect to frequency resource assignment (DL/UL), according to 3rd Generation Partnership Project (3GPP) technical specification (TS) 38.212, both UL and DL resource assignments support only 1 single MCS assignment applicable to all assigned resource blocks. DCI Format 0_0 refers to an MCS of 5 bits. DCI Format 0_1 refers to, for TB 1, an MCS of 5 bits as defined in Clause 6.1.4.1 of 3GPP TS 38.214, and for TB 2 (only present if maxRank or maxMIMO-Layers is larger than 4), an MCS of 5 bits as defined in Clause 6.1.4.1 of 3GPP TS 38.214.

DCI Format 0_2 refers to an MCS of 5 bits as defined in Clause 6.1.4.1 of 3GPP TS 38.214. DCI Format 0_3 is used for the scheduling of one physical uplink shared channel (PUSCH) in one cell, or multiple PUSCHs in multiple cells with one PUSCH per cell. The MCS is a number of bits determined by the following: block number 1, block number 2, . . . , block number

$${N}_{cell}^{UL} .$$

Each block corresponds to the MCS for a cell, and the blocks are placed according to an ascending order of a serving cell index, with block number 1 corresponding to the MCS for the cell with the smallest serving cell index. Each block is 5 bits as defined in Clause 6.1.4.1 of 3GPP TS 38.214.

DCI Format 1_0 refers to an MCS of 5 bits. DCI Format 11, for TB 1, refers to an MCS of 5 bits as defined in Clause 5.1.3.1 of 3GPP TS 38.214, and for TB 2 (only present if maxNrofCodeWordsScheduledByDCI equals 2), refers to an MCS of 5 bits as defined in Clause 5.1.3.1 of 3GPP TS 38.214. DCI Format 1_2 refers to an MCS of 5 bits as defined in Clause 5.1.3.1 of 3GPP TS 38.214.

DCI Format 1_3 is used for the scheduling of one physical downlink shared channel (PDSCH) in one cell, or multiple PDSCHs in multiple cells with one PDSCH per cell. For TB 1: the MCS is a number of bits determined by the following: block number 1, block number 2, . . . , block number

$${N}_{c e l l}^{D L} .$$

Each block corresponds to the MCS for a cell, and the blocks are placed according to an ascending order of a serving cell index, with block number 1 corresponding to the MCS for the cell with the smallest serving cell index. Each block is 5 bits as defined in Clause 6.1.4.1 of 3GPP TS 38.214. For TB 2: the MCS is a number of bits determined by the following: block number 1, block number 2, . . . , block number

$${N}_{cell}^{DL , 3} .$$

DCI Format 4_0 refers to an MCS of 5 bits as defined in Clause 5.1.3 of 3GPP TS38.214. DCI Format 4_1 refers to an MCS of 5 bits as defined in Clause 5.1.3 of 3GPP TS38.214. DCI Format 4_2 refers to, for TB 1, an MCS of 5 bits as defined in Clause 5.1.3.1 of 3GPP TS 38.214, and for TB 2 (only present if maxNrofCodeWordsScheduledByDCI equals 2), an MCS of 5 bits as defined in Clause 5.1.3.1 of 3GPP TS 38.214.

While DCI formats 0_3/1_3 are capable of signaling a plurality of MCS fields, each such MCS field is applicable to a whole cell, and therefore to a single TB (i.e., the same MCS is applied to a TB).

With respect to resource allocation in frequency domain, the UE 104 determines the resource block assignment in frequency domain using the resource allocation field in the detected physical downlink control channel (PDCCH) DCI except for a PUSCH transmission scheduled by a random access response (RAR) UL grant or fallbackRAR UL grant, in which case the frequency domain resource allocation is determined according to clause 8.3 of 3GPP 38.213 or a MsgA PUSCH transmission with frequency domain resource allocation determined according to clause 8.1A of 3GPP 38.213. Three UL resource allocation schemes type 0, type 1 and type 2 are supported. UL resource allocation scheme type 0 is supported for PUSCH only when transform precoding is disabled. UL resource allocation scheme type 1 and type 2 are supported for PUSCH for both cases when transform precoding is enabled or disabled.

If the scheduling DCI is configured to indicate the UL resource allocation type as part of the “Frequency domain resource” assignment field by setting a higher layer parameter resourceAllocation in pusch-Config to “dynamicSwitch”, for DCI format 0_1 or setting a higher layer parameter resourceAllocationDCI-0-2 in pusch-Config to “dynamicSwitch” for DCI format 0_2 or setting a higher layer parameter resourceAllocationDCI-0-3 in pusch-ConfigDCI-0-3 to “dynamicSwitch” for DCI format 03, the UE 104 uses UL resource allocation type 0 or type 1 as defined by this DCI field. Otherwise, the UE uses the UL frequency resource allocation type as defined by the higher layer parameter resourceAllocation for DCI format 0_1 or the higher layer parameter resourceAllocationDCI-0-2 for DCI format 0_2 or by the higher layer parameter resourceAllocationDCI-0-3 for DCI format 0_3. The UE 104 assumes that when the scheduling PDCCH is received with DCI format 0_1/0_3 and useInterlacePUCCH-PUSCH in bandwidth part (BWP)-UplinkDedicated is configured, UL type 2 resource allocation is used.

The UE 104 assumes that when the scheduling PDCCH is received with DCI format 0_0, then UL resource allocation type 1 is used, except when any of the higher layer parameters useInterlacePUCCH-PUSCH in BWP-UplinkCommon and useInterlacePUCCH-PUSCH in BWP-UplinkDedicated is configured in which case UL resource allocation type 2 is used. The UE 104 expects that either none or both of useInterlacePUCCH-PUSCH in BWP-UplinkCommon and useInterlacePUCCH-PUSCH in BWP-UplinkDedicated is configured.

If a bandwidth part indicator field is not configured in the scheduling DCI or the UE 104 does not support active bandwidth part change via DCI, the RB indexing for UL type 0, type 1 and type 2 resource allocation is determined within the active bandwidth part of the UE 104. If a bandwidth part indicator field is configured in the scheduling DCI and the UE supports active bandwidth part change via DCI, the RB indexing for UL type 0, type 1, type 2 resource allocation is determined within the bandwidth part of the UE 104 indicated by bandwidth part indicator field value in the DCI. The UE 104, upon detection of PDCCH intended for the UE 104, determines first the UL bandwidth part and then the resource allocation within the bandwidth part. RB numbering starts from the lowest RB in the determined UL bandwidth part.

In UL resource allocation of type 0, the resource block assignment information includes a bitmap indicating the resource block groups (RBGs) that are allocated to the scheduled UE 104 where a RBG is a set of consecutive virtual resource blocks defined by higher layer parameter rbg-Size for DCI format 0_1/0_2 configured in pusch-Config or rbg-SizeDCI-0-3 for DCI format 0_3 configured in pusch-ConfigDCI-0-3 and the size of the bandwidth part as defined in Table 1.

TABLE 1
Nominal RBG size P

| Bandwidth Part Size | Configuration 1 | Configuration 2 | Configuration 3 |
|---|---|---|---|
| 1-36 | 2 | 4 | 8 |
| 37-72 | 4 | 8 | 16 |
| 73-144 | 8 | 16 | 32 |
| 145-275 | 16 | 16 | 32 |

The total number of RBGs (N_{RBG}) for a UL bandwidth part i of size

$${N}_{BWP}^{s ize}$$

PRBs is given by

$${N}_{RBG} = ⌈ ( {N}_{BWP , i}^{size} + ( {N}_{BWP , i}^{start} mod P ) ) / P ⌉$$

where
the size of the first RBG is

$${RBG}_{0}^{size} = P - {N}_{BWP , i}^{start} mod P ,$$

the size of the last RBG is

$${RBG}_{last}^{size} = ( {N}_{BWB , i}^{start} + {N}_{BWP , i}^{size} ) mod P if ( {N}_{BWP , i}^{start} + {N}_{BWP , i}^{size} ) mod P > 0 and P$$

otherwise.
the size of all other RBG is P.

The bitmap is of size N_{RBG} bits with one bitmap bit per RBG such that each RBG is addressable. The RBGs are indexed in the order of increasing frequency of the bandwidth part and starting at the lowest frequency. The order of RBG bitmap is such that RBG 0 to RBG N_{RBG}−1 are mapped from most significant bit (MSB) to least significant bit (LSB) of the bitmap. The RBG is allocated to the UE 104 if the corresponding bit value in the bitmap is 1, the RBG is not allocated to the UE 104 otherwise. In frequency range 1, only “almost contiguous allocation” defined in 3GPP TS 38.101-1 is allowed as non-contiguous allocation per component carrier for UL RB allocation for CP-OFDM. In frequency range 2, non-contiguous allocation per component carrier for UL RB allocation for CP-OFDM is not supported.

In UL resource allocation of type 1, the resource block assignment information indicates to a scheduled UE 104 a set of contiguously allocated non-interleaved virtual resource blocks within the active bandwidth part of size

$${N}_{BWP}^{s i z e}$$

PRBs except for the case when DCI format 0_0 is decoded in any common search space in which case the size of the initial UL bandwidth part

$${N}_{BWP , 0}^{size}$$

is used. An UL type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by

```
  $if ( {L}_{RBs} - 1 ) \leq ⌊ {N}_{BWP}^{size} / 2 ⌋ then$
    $RIV = {N}_{BWP}^{size} ( {L}_{RBs} - 1 ) + {RB}_{start}$
  else
    $RIV = {N}_{BWP}^{size} ( {N}_{BWP}^{size} - {L}_{RBs} + 1 ) + ( {N}_{BWP}^{size} - 1 - {RB}_{start} )$
$where {L}_{RBs} \geq 1 and does not exceed {N}_{BWP}^{size} - {RB}_{start} .$
```

When the DCI size for DCI format 0_0 in UE-specific search space (USS) is derived from the initial UL BWP with size

$${N}_{BWP}^{initial}$$

but applied to another active BWP with size of

$${N}_{BWP}^{initial} ,$$

an UL type 1 resource block assignment field includes a resource indication value (RIV) corresponding to a starting resource block

$$R {B}_{start} = 0 , K , 2 \cdot K , … , ( {N}_{BWP}^{initial} - 1 ) \cdot K$$

and a length in terms of virtually contiguously allocated resource blocks

$${L}_{RBs} = K , 2 \cdot K , … , {N}_{BWP}^{initial} \cdot K .$$

The resource indication value is defined by

```
  $if ( {L}_{RBs}^{′} - 1 ) \leq ⌊ {N}_{BWP}^{size} / 2 ⌋ then$
    $RIV = {N}_{BWP}^{initial} ( {L}_{RBs}^{′} - 1 ) + {RB}_{start}^{′}$
  else
    $RIV = {N}_{BWP}^{initial} ( {N}_{BWP}^{initial} - {L}_{RBs}^{′} + 1 ) + ( {N}_{BWP}^{initial} - 1 - {RB}_{start}^{′} )$
```

where L′_{RBs}=L_{RB}/K, RB′ₛₜₐᵣₜ=RBₛₜₐᵣₜ/K and where L′_{RBs} does not exceed

$${N}_{BWP}^{initial} - {RB}_{start}^{′} . If {N}_{BWP}^{active} > {N}_{BWP}^{initial} ,$$

K is the maximum value from set {1, 2, 4, 8} which satisfies

$$K \leq ⌊ {N}_{BWP}^{active} / {N}_{BWP}^{initial} ⌋ ;$$

otherwise K=1.

When the scheduling grant is received with DCI format 0_2 or 0_3, an UL type 1 resource allocation field includes a resource indication value (RIV) corresponding to a starting resource block group RBGₛₜₐᵣₜ=0, 1, . . . , N_{RBG}−1 and a length in terms of virtually contiguously allocated resource block groups L_{RBGS}=1, . . . , N_{RBG}, where the resource block groups are defined as discussed above with reference to UL resource allocation type 0 with P defined by resourceAllocationType1GranularityDCI-0-2 for DCI format 0_2 and by resourceAllocationType1GranularityDCI-0-3 for DCI format 0_3 if the UE 104 is configured with higher layer parameter resourceAllocationType1GranularityDCI-0-2 or resourceAllocationType1GranularityDCI-0-3, and P=1 otherwise. The resource indication value is defined by

```
if (L_{RBGs} −1)≤└N_{RBG} /2┘ then
  RIV = N_{RBG}(L_{RBGs} −1) + RBGₛₜₐᵣₜ
else
  RIV = N_{RBG}(N_{RBG} − L_{RBGs} + 1) + (N_{RBG} − 1 − RBGₛₜₐᵣₜ)
```

where L_{RBGs}≥1 and does not exceed N_{RBG}−RBGₛₜₐᵣₜ.

In UL resource allocation of type 2, the resource block assignment information defined in 3GPP TS 38.212 indicates to a UE 104 a set of up to M interlace indices, and for DCI format 0_0 monitored in a UE-specific search space and DCI formats 0_1 and 0_3 a set of up to

$${N}_{RB - set , UL}^{BWP}$$

contiguous RB sets, where M and interlace indexing are defined in Clause 4.4.4.6 of 3GPP TS 38.211. Within the active UL BWP, the assigned physical resource block n is mapped to virtual resource block n. For DCI format 0_0 monitored in a UE-specific search space and DCI formats 0_1 and 0_3, the UE 104 determines the resource allocation in frequency domain as an intersection of the resource blocks of the indicated interlaces and the union of the indicated set of RB sets and intra-cell guard bands between the indicated RB sets, if any. For DCI format 0_0 monitored in a common search space, the UE 104 determines the resource allocation in frequency domain as an intersection of the resource blocks of the indicated interlaces and a single UL RB set of the active UL BWP. For DCI format 0_0 monitored in a common search space (CSS) with cyclic redundancy check (CRC) scrambled by a radio network temporary identifier (RNTI) other than temporary cell RNTI (TC-RNTI), the UL RB set is the lowest indexed one amongst UL RB set(s) that intersects the lowest-indexed control channel element (CCE) of the PDCCH in which the UE 104 detects the DCI format 0_0 in the active downlink BWP. When the PDCCH reception includes two PDCCH candidates from two respective search space sets, as described in clause 10.1 of 3GPP TS 38.213, for the purpose of determining the UL RB set of a PUSCH when scheduled by DCI format 0_0 monitored in a CSS with CRC scrambled by an RNTI other than TC-RNTI, the control resource set (CORESET) with lower identifier (ID) among two CORESETs associated with two PDCCH candidates is used. If there is no intersection, the UL RB set is RB set 0 in the active UL BWP. For DCI format 0_0 with CRC scrambled by TC-RNTI, the UL RB set is the same one in which the UE transmits the physical random access channel (PRACH) associated with the RAR UL grant, in which case the UE assumes that the UL RB set is defined as when the UE is not configured with intraCellGuardBandsUL-List.

For μ=0, the X=6 MSBs of the resource block assignment information indicates to a UE 104 a set of allocated interlace indices m₀+l, where the indication consists of a resource indication value (RIV). For 0≤RIV<M(M+1)/2, l=0, 1, . . . L−1 the resource indication value corresponds to the starting interlace index m₀ and the number of contiguous interlace indices L(L≥1). The resource indication value is defined by:

```
if (L − 1) ≤ └M/2┘ then
  RIV = M(L − 1) + m₀
else
  RIV = M(M − L + 1) + (M − 1 − m₀)
```

For RIV≥M(M+1)/2, the resource indication value corresponds to the starting interlace index m₀ and the set of values l according to Table 2.

TABLE 2
m₀ and l for RIV ≥ M(M + 1)/2.

| RIV − M(M + 1)/2 | m₀ | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, |
| | | 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

For μ=1, the X=5 MSBs of the resource block assignment information comprise a bitmap indicating the interlaces that are allocated to the scheduled UE. The bitmap is of size M bits with one bitmap bit per interlace such that each interlace is addressable, where M and interlace indexing is defined in Clause 4.4.4.6 of 3GPP TS 38.211. The order of interlace bitmap is such that interlace 0 to interlace M−1 are mapped from MSB to LSB of the bitmap. An interlace is allocated to the UE 104 if the corresponding bit value in the bitmap is 1; otherwise, the interlace is not allocated to the UE 104.

For DCI format 0_0 monitored in a UE-specific search space and DCI formats 0_1 and 0_3 for both μ=0 and μ=1, the

$$Y = ⌈ {log}_{2} \frac{{N}_{RB - set , UL}^{BWP} ( {N}_{RB - set , UL}^{BWP} + 1 )}{2} ⌉$$

LSBs of the resource block assignment information indicate to a UE 104 a set of contiguously allocated RB sets for PUSCH scheduled by DCI format 0_0 monitored in a UE-specific search space, DCI formats 0_1 and 0_3 and Type 1 and Type 2 configured grant. The resource allocation field consists of a resource indication value (RIV_{RB-set}). For

$$0 \leq {RIV}_{R B - s e t} < {N}_{RB - set , UL}^{BWP} ( {N}_{RB - set , UL}^{BWP} + 1 ) / 2 , l = 0 , 1 , … {L}_{R Bset} - 1$$

the resource indication value corresponds to the starting RB set index

$${N}_{RB - set , UL}^{start}$$

and the number of contiguous RB sets L_{RB-set}. The resource indication value is defined by;

```
  $if ( {L}_{RB - set} - 1 ) \leq ⌊ {N}_{RB - set , UL}^{BWP} / 2 ⌋ then$
    ${RIV}_{RB - set} = {N}_{RB - set , UL}^{BWP} ( {L}_{RB - set} - 1 ) + {N}_{RB - set , UL}^{start}$
  else
    ${RIV}_{RB - set} = {N}_{RB - set , UL}^{BWP} ( {N}_{RB - set , UL}^{BWP} - {L}_{RB - set} + 1 ) + ( {N}_{RB - set , UL}^{BWP} - 1 - {N}_{RB - set , UL}^{start} )$
$where {N}_{RB - set , UL}^{start} = 0 , 1 , … {N}_{RB - set , UL}^{BWP} - 1 , {L}_{RB - set} \geq 1 and does not exceed {N}_{RB - set , UL}^{BWP} - {N}_{RB - set , UL}^{start}$
```

If transform precoding is enabled, then the UE 104 transmits PUSCH on the lowest-indexed

$${M}_{RB}^{PUSCH}$$

PRBs amongst the PRBs indicated by the frequency domain resource assignment information.

$${M}_{RB}^{PUSCH}$$

is the largest integer not greater than the number of RBs indicated by the frequency domain resource assignment information that fulfils the conditions in Clause 6.3.1.4 of 3GPP TS 38.211.

The following discussion refers to, for example, a situation where an NE 102 (e.g., a gNB) communicates (e.g., transmits, signals, sends) DCI allocating UL resources for one or more TBs, an in some situations with at least a first MCS level indication included in the DCI. In one or more implementations, the UE 104 applies the first DCI MCS level to a first data block, where the data for the first data block is from the LCH that has the most stringent quality of service requirements. For example, this may be the LCH with the highest priority. The corresponding data may be used for communication (e.g., transmission, signaling, sending) in one or more TBs, according to the resource assignment (e.g., the DCI) communicated (e.g., transmitted, signaled, sent) by the NE 102. According to one example, the transmitter (e.g., the NE 102) as well as the receiver (e.g., the UE 104) are aware of the resources used for the communication (e.g., transmission, signaling, sending) of the first data block. The resources for the first data block may be indicated explicitly by the DCI, or may be determined by an established relationship between information contained in the DCI and corresponding resources. For example, a DCI may indicate a number of pluralities of resource blocks for transmission, and the first MCS level for the first data block is used to determine the communicated (e.g., transmitted, signaled, sent) information on a first plurality of resource blocks. According to another example, it may be established that a fraction or percentage of the resource blocks indicated by the DCI are employed for communication (e.g., transmission, signaling, sending) of the first data block using the first MCS level, such as the first 50% of the assigned resource blocks. According to another example, the first data block is communicated (e.g., transmitted, signaled, sent) using the first MCS level by a first TB on a first plurality of resource blocks.

In one or more implementations, the NE 102 determines and communicates (e.g., transmits, sends, signals) an indication of the first MCS level to the UE 104 based on the QoS requirements of the highest demanding or highest priority LCH for which data is available in the buffer of the UE 104, based on the NE 102's understanding or knowledge about the UE 104 buffer status. Such knowledge may have been provided by, for example, a buffer status report (BSR) communicated (e.g., transmitted, signaled, sent) from the UE 104 to the NE 102.

In one or more implementations, the UE 104 may determine a second MCS level for communication (e.g., transmission, signaling, sending) of a second data block coming from a LCH that is different from the LCH providing data for the first data block. For example, the first data block is from LCH1, and the second data block is from LCH3. To inform the receiver about the second MCS level, the communication (e.g., transmission, signaling, sending) by the UE 104 includes UL control information (UCI) carrying at least the second MCS level for the second data block. The second data block may be multiplexed together with the first data block in a same TB, or these may be associated with distinct TBs. According to one example, a second MCS level corresponds to a higher spectral efficiency transmission than a first MCS level.

In this way, it is guaranteed that at least the first data block is communicated (e.g., transmitted, signaled, sent) using the first MCS, so that the NE 102 is able to decode at least the data of the first (most important) LCH even for cases when UCI is lost or corrupted during the UL transmission.

In one or more implementations, the UCI includes a plurality of second MCS levels, and optionally an indication of the resources to which the corresponding second MCS level applies. For example, the UCI includes MCS level 10 and 12, and additionally the number and/or location of the resource blocks that are being communicated (e.g., transmitted, signaled, sent) using MCS levels 10 and 12, respectively.

In one or more implementations, the second MCS level is indicated as an offset from the first MCS level (as indicated by the DCI). This may offer overhead reduction, since instead of communicating (e.g., transmitting, signaling, sending) e.g., 5 bits for a full choice of the second MCS level, only an offset is being communicated (e.g., transmitted, signaled, sent) with a size of 3 bits. Assuming that the offset can indicate values {0, 1, 2, . . . , 7}, in this way the UCI can indicate the second MCS level to be equivalent to {first MCS level, first MCS level+1, first MCS level+2, . . . , first MCS level+7}.

In one or more implementations, the UE 104 is restricted in its freedom of choice for the second MCS level. For example, the second MCS level may be limited to those levels that employ the same modulation scheme or modulation level as the first MCS level. For example, if the first MCS level is associated with quadrature phase shift keying (QPSK) modulation, then the UE 104 may select the second MCS level only from the subset of MCS levels associated with QPSK. According to another example, the NE 102 may determine and indicate a restricted set of MCS levels that are available for selection as second MCS level. The indication of the restricted set may be facilitated by DCI, or by configuration such as by MAC control element (CE) or RRC signaling. Accordingly, the UE 104 may then indicate the selected second MCS level by its index within the restricted set of MCS levels. For example, if the restricted set consists of MCS levels 8, 10, 12, 16, then the UE 104 may indicate index “2” to signal that the second MCS level is MCS level 10 (e.g., the second MCS level within the restricted list).

In one or more implementations, the UCI is communicated (e.g., transmitted, sent, signaled) using a predefined or predetermined MCS level, along with the subset or full set of the plurality of data blocks being scheduled by the DCI. A predefined or predetermined MCS level refers to an MCS level known to both the UE 104 and the NE 102 prior to the UE 104 communicating (e.g., transmitting, sending, signaling) the UCI to the NE 102. For example, the NE 102 may communicate (e.g., transmit, send, signal) the MCS level to the UE 104 in the DCI, the NE 102 may have communicated (e.g., transmitted, sent, signaled) the MCS level to the UE 104 using MAC CE or RRC signaling, and the like.

Additionally, or alternatively, the UCI is communicated (e.g., transmitted, signaled, sent) using the first MCS level. Additionally, or alternatively, the UCI is communicated (e.g., transmitted, signaled, sent) using a third MCS level that is being indicated by a DCI.

Accordingly, defining and indicating an MCS level for a highest priority LCH is discussed herein. A UE choosing the MCS for lower priority LCHs and conveys those choices to the NE via UCI is also discussed herein. The NE (e.g., a gNB) configuring a restricted set of MCS levels that can be chosen by the UE is also discussed herein. A UCI communicated (e.g., transmitted, signaled, sent) using an indicated MCS level is also discussed herein.

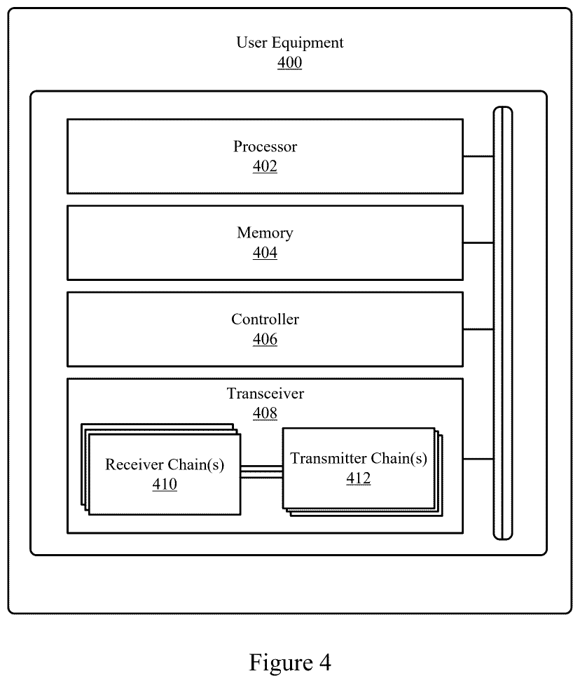

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving DCI that allocates at least one set of RBs; transmitting, using a first MCS level of a plurality of MCS levels, a first data block on a first subset of RBs of the at least one set of RBs; and transmitting, using a second MCS level of the plurality of MCS levels, a second data block on a second subset of RBs of the at least one set of RBs, where the first MCS level is different from the second MCS level.

Additionally, the UE 400 may be configured to support any one or combination of where the DCI indicates the first MCS level; receiving an indication of a set of multiple MCS levels; and selecting, as the second MCS level, one of the MCS levels in the set of multiple MCS levels; where the DCI indicates frequency resources for transmission of the first data block; where the first MCS level is based at least in part on QoS requirements of a highest priority LCH associated with data available in a buffer of the UE; selecting the second MCS level of the plurality of MCS levels based at least in part on a priority of a LCH associated with the second data block; multiplexing the first data block and the second data block in a single TB; transmitting UCI that indicates the second MCS level; transmitting the UCI using at least one of a predefined MCS level or the first MCS level; transmitting the UCI using the third MCS level.

Additionally, or alternatively, the UE 400 may support at least one memory (e.g., the memory 404) and at least one processor (e.g., the processor 402) coupled with the at least one memory and configured to cause the UE to: receive DCI that allocates at least one set of RBs; transmit, using a first MCS level of a plurality of MCS levels, a first data block on a first subset of RBs of the at least one set of RBs; and transmit, using a second MCS level of the plurality of MCS levels, a second data block on a second subset of RBs of the at least one set of RBs, where the first MCS level is different from the second MCS level.

Additionally, the UE 400 may be configured to support any one or combination of where the DCI indicates the first MCS level; where the at least one processor is further operable to cause the UE to: receive an indication of a set of multiple MCS levels; and select, as the second MCS level, one of the MCS levels in the set of multiple MCS levels; where the DCI indicates frequency resources for transmission of the first data block; where the first MCS level is based at least in part on QoS requirements of a highest priority LCH associated with data available in a buffer of the UE; where the at least one processor is further operable to cause the UE to select the second MCS level of the plurality of MCS levels based at least in part on a priority of a LCH associated with the second data block; where the at least one processor is further operable to cause the UE to multiplex the first data block and the second data block in a single TB; where the at least one processor is further operable to cause the UE to transmit UCI that indicates the second MCS level; where to transmit the UCI, the at least one processor is further operable to cause the UE to transmit the UCI using at least one of a predefined MCS level or the first MCS level; where the DCI indicates a third MCS level, and where to transmit the UCI, the at least one processor is further operable to cause the UE to transmit the UCI using the third MCS level.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

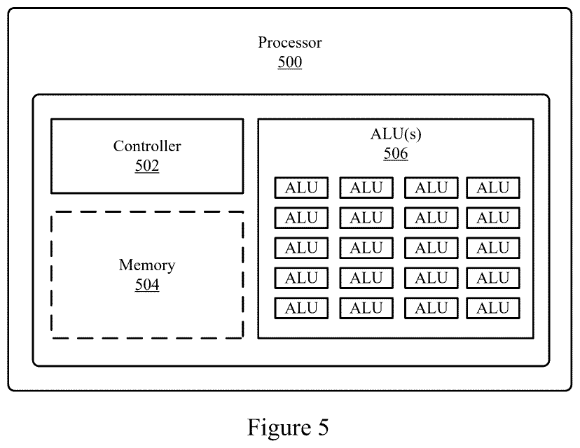

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to: receive DCI that allocates at least one set of RBs; transmit, using a first MCS level of a plurality of MCS levels, a first data block on a first subset of RBs of the at least one set of RBs; and transmit, using a second MCS level of the plurality of MCS levels, a second data block on a second subset of RBs of the at least one set of RBs, where the first MCS level is different from the second MCS level.

Additionally, the processor 500 may be configured to or operable to support any one or combination of where the DCI indicates the first MCS level; where the at least one controller is further operable to cause the processor to: receive an indication of a set of multiple MCS levels; and select, as the second MCS level, one of the MCS levels in the set of multiple MCS levels; where the DCI indicates frequency resources for transmission of the first data block; where the first MCS level is based at least in part on QoS requirements of a highest priority LCH associated with data available in a buffer of the UE; where the at least one controller is further operable to cause the processor to select the second MCS level of the plurality of MCS levels based at least in part on a priority of a LCH associated with the second data block; where the at least one controller is further operable to cause the processor to multiplex the first data block and the second data block in a single TB; where the at least one controller is further operable to cause the processor to transmit UCI that indicates the second MCS level; where to transmit the UCI, the at least one controller is further operable to cause the processor to transmit the UCI using at least one of a predefined MCS level or the first MCS level; where the DCI indicates a third MCS level, and where to transmit the UCI, the at least one controller is further operable to cause the processor to transmit the UCI using the third MCS level.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to: transmit DCI that allocates at least one set of RBs; receive, using a first MCS level of a plurality of MCS levels, a first data block on a first subset of RBs of the at least one set of RBs; and receive, using a second MCS level of the plurality of MCS levels, a second data block on a second subset of RBs of the at least one set of RBs, where the first MCS level is different from the second MCS level.

Additionally, the processor 500 may be configured to or operable to support any one or combination of where the at least one controller is further operable to cause the processor to include, in the DCI, an indication of the first MCS level; where the at least one controller is further operable to cause the processor to include, in the DCI, an indication of a set of multiple MCS levels; where the at least one controller is further operable to cause the processor to receive UCI that indicates the second MCS level of the plurality of MCS levels; where the DCI indicates frequency resources for transmission of the first data block; where the at least one controller is further operable to cause the processor to: receive a buffer status report; and determine the first MCS level based at least in part on QoS requirements of a highest priority LCH associated with data indicated in the buffer status report; where the first data block is multiplexed with the second data block in a single TB; where the at least one controller is further operable to cause the processor to receive an UCI using at least one of a predefined MCS level or the first MCS level; where the at least one controller is further operable to cause the processor to include, in the DCI, an indication of a third MCS level, and receive an UCI using the third MCS level.

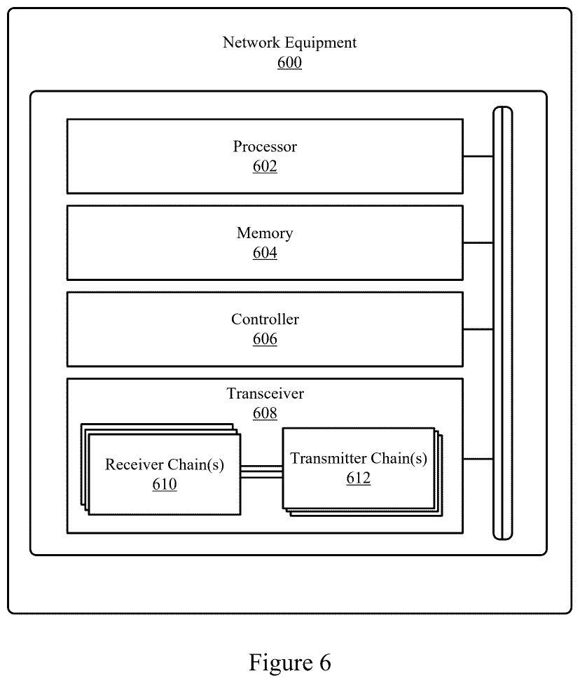

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for transmitting DCI that allocates at least one set of RBs; receiving, using a first MCS level of a plurality of MCS levels, a first data block on a first subset of RBs of the at least one set of RBs; and receiving, using a second MCS level of the plurality of MCS levels, a second data block on a second subset of RBs of the at least one set of RBs, where the first MCS level is different from the second MCS level.

Additionally, the NE 600 may be configured to support any one or combination of including, in the DCI, an indication of the first MCS level; including, in the DCI, an indication of a set of multiple MCS levels; receiving UCI that indicates the second MCS level of the plurality of MCS levels; where the DCI indicates frequency resources for transmission of the first data block; receiving a buffer status report; and determining the first MCS level based at least in part on QoS requirements of a highest priority LCH associated with data indicated in the buffer status report; where the first data block is multiplexed with the second data block in a single TB; receiving an UCI using at least one of a predefined MCS level or the first MCS level; including, in the DCI, an indication of a third MCS level, and receive an UCI using the third MCS level.

Additionally, or alternatively, the NE 600 may support at least one memory (e.g., the memory 604) and at least one processor (e.g., the processor 602) coupled with the at least one memory and configured to cause the NE to: transmit DCI that allocates at least one set of RBs; receive, using a first MCS level of a plurality of MCS levels, a first data block on a first subset of RBs of the at least one set of RBs; and receive, using a second MCS level of the plurality of MCS levels, a second data block on a second subset of RBs of the at least one set of RBs, where the first MCS level is different from the second MCS level.

Additionally, the NE 600 may be configured to support any one or combination of where the at least one processor is further operable to cause the NE to include, in the DCI, an indication of the first MCS level; where the at least one processor is further operable to cause the NE to include, in the DCI, an indication of a set of multiple MCS levels; where the at least one processor is further operable to cause the NE to receive UCI that indicates the second MCS level of the plurality of MCS levels; where the DCI indicates frequency resources for transmission of the first data block; where the at least one processor is further operable to cause the NE to: receive a buffer status report; and determine the first MCS level based at least in part on QoS requirements of a highest priority LCH associated with data indicated in the buffer status report; where the first data block is multiplexed with the second data block in a single TB; where the at least one processor is further operable to cause the NE to receive an UCI using at least one of a predefined MCS level or the first MCS level; where the at least one processor is further operable to cause the NE to include, in the DCI, an indication of a third MCS level, and receive an UCI using the third MCS level.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

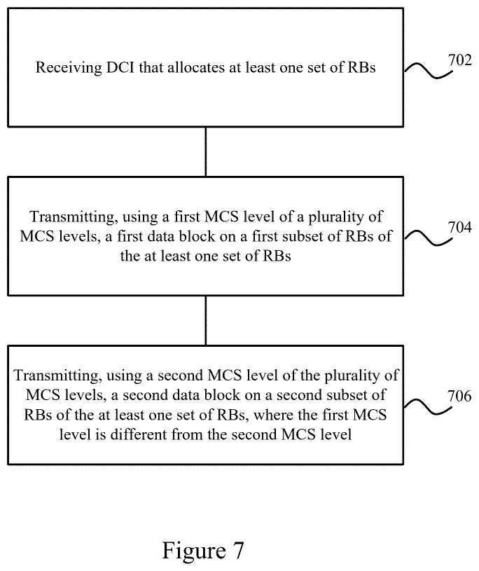

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include receiving DCI that allocates at least one set of RBs. The operations of 702 may be performed in accordance with examples as described herein. In some implementations, aspects of the operations of 702 may be performed by a UE as described with reference to FIG. 4.

At 704, the method may include transmitting, using a first MCS level of a plurality of MCS levels, a first data block on a first subset of RBs of the at least one set of RBs. The operations of 704 may be performed in accordance with examples as described herein. In some implementations, aspects of the operations of 704 may be performed by a UE as described with reference to FIG. 4.

At 706, the method may include transmitting, using a second MCS level of the plurality of MCS levels, a second data block on a second subset of RBs of the at least one set of RBs, where the first MCS level is different from the second MCS level. The operations of 706 may be performed in accordance with examples as described herein. In some implementations, aspects of the operations of 706 may be performed a UE as described with reference to FIG. 4.

It should be noted that the method described herein describes a possible implementation, and that the operations and the steps may be rearranged or otherwise modified and that other implementations are possible.

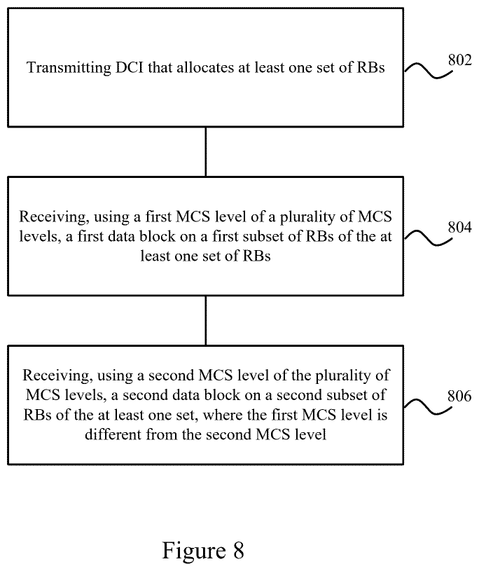

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include transmitting DCI that allocates at least one set of RBs. The operations of 802 may be performed in accordance with examples as described herein. In some implementations, aspects of the operations of 802 may be performed by an NE as described with reference to FIG. 6.

At 804, the method may include receiving, using a first MCS level of a plurality of MCS levels, a first data block on a first subset of RBs of the at least one set of RBs. The operations of 804 may be performed in accordance with examples as described herein. In some implementations, aspects of the operations of 804 may be performed by an NE as described with reference to FIG. 6.

At 806, the method may include receiving, using a second MCS level of the plurality of MCS levels, a second data block on a second subset of RBs of the at least one set, where the first MCS level is different from the second MCS level. The operations of 806 may be performed in accordance with examples as described herein. In some implementations, aspects of the operations of 806 may be performed an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive downlink control information (DCI) that allocates at least one set of resource blocks (RBs);
transmit, using a first modulation and coding scheme (MCS) level of a plurality of MCS levels, a first data block on a first subset of RBs of the at least one set of RBs; and
transmit, using a second MCS level of the plurality of MCS levels, a second data block on a second subset of RBs of the at least one set of RBs, wherein the first MCS level is different from the second MCS level.

2. The UE of claim 1, wherein the DCI indicates the first MCS level.

3. The UE of claim 1, wherein the at least one processor is further operable to cause the UE to:
receive an indication of a set of multiple MCS levels; and
select, as the second MCS level, one of the MCS levels in the set of multiple MCS levels.

4. The UE of claim 1, wherein the DCI indicates frequency resources for transmission of the first data block.

5. The UE of claim 1, wherein the first MCS level is based at least in part on quality of service (QoS) requirements of a highest priority logical channel (LCH) associated with data available in a buffer of the UE.

6. The UE of claim 1, wherein the at least one processor is further operable to cause the UE to select the second MCS level of the plurality of MCS levels based at least in part on a priority of a logical channel (LCH) associated with the second data block.

7. The UE of claim 1, wherein the at least one processor is further operable to cause the UE to multiplex the first data block and the second data block in a single transport block (TB).

8. The UE of claim 1, wherein the at least one processor is further operable to cause the UE to transmit uplink control information (UCI) that indicates the second MCS level.

9. The UE of claim 8, wherein to transmit the UCI, the at least one processor is further operable to cause the UE to transmit the UCI using at least one of a predefined MCS level or the first MCS level.

10. The UE of claim 8, wherein the DCI indicates a third MCS level, and wherein to transmit the UCI, the at least one processor is further operable to cause the UE to transmit the UCI using the third MCS level.

11. A network equipment (NE) for wireless communication, comprising:
at least one memory; and
at least one processor coupled with the at least one memory and operable to cause the NE to:
transmit downlink control information (DCI) that allocates at least one set of resource blocks (RBs);
receive, using a first modulation and coding scheme (MCS) level of a plurality of MCS levels, a first data block on a first subset of RBs of the at least one set of RBs; and
receive, using a second MCS level of the plurality of MCS levels, a second data block on a second subset of RBs of the at least one set of RBs, wherein the first MCS level is different from the second MCS level.

12. The NE of claim 11, wherein the at least one processor is further operable to cause the NE to include, in the DCI, an indication of the first MCS level.

13. The NE of claim 11, wherein the at least one processor is further operable to cause the NE to include, in the DCI, an indication of a set of multiple MCS levels.

14. The NE of claim 11, wherein the at least one processor is further operable to cause the NE to receive uplink control information (UCI) that indicates the second MCS level of the plurality of MCS levels.

15. The NE of claim 11, wherein the DCI indicates frequency resources for transmission of the first data block.

16. The NE of claim 11, wherein the at least one processor is further operable to cause the NE to:
receive a buffer status report; and
determine the first MCS level based at least in part on quality of service (QoS) requirements of a highest priority logical channel (LCH) associated with data indicated in the buffer status report.

17. The NE of claim 11, wherein the first data block is multiplexed with the second data block in a single transport block (TB).

18. The NE of claim 11, wherein the at least one processor is further operable to cause the NE to receive an uplink control information (UCI) using at least one of a predefined MCS level or the first MCS level.

19. A method performed by a user equipment (UE), the method comprising:
receiving downlink control information (DCI) that allocates at least one set of resource blocks (RBs);
transmitting, using a first modulation and coding scheme (MCS) level of a plurality of MCS levels, a first data block on a first subset of RBs of the at least one set of RBs; and
transmitting, using a second MCS level of the plurality of MCS levels, a second data block on a second subset of RBs of the at least one set of RBs, wherein the first MCS level is different from the second MCS level.

20. A method performed by a network equipment (NE), the method comprising:
transmitting downlink control information (DCI) that allocates at least one set of resource blocks (RBs);
receiving, using a first modulation and coding scheme (MCS) level of a plurality of MCS levels, a first data block on a first subset of RBs of the at least one set of RBs; and
receiving, using a second MCS level of the plurality of MCS levels, a second data block on a second subset of RBs of the at least one set of RBs, wherein the first MCS level is different from the second MCS level.
